(19) United States
(12) Patent Application Publication
(10) Pub. No.: US 2002/0106806 A1
(43) Pub. Date: Aug. 8, 2002

(54) Test method for optimizing polymers or polymer-forming components

(76) Inventors: Hermann Bach, Mt. Lebanon, PA (US); Christoph Gurtler, Koln (DE)

Correspondence Address: BAYER CORPORATION, PATENT DEPARTMENT, 100 BAYER ROAD, PITTSBURGH, PA, 15205, US

(21) Appl. No.: 09/990,129

(22) Filed: Nov. 21, 2001

(30) Foreign Application Priority Data
Nov. 27, 2000 (DE) 10058879.4

(51) Int. Cl. G01N 21/76

(52) U.S. Cl. 436/85; 436/172

(57) ABSTRACT

A test method is described for discovering polymer or polymer-forming components having favorable properties. The method comprises the steps of preparing one or more sets of polymer solutions or solutions of polymer-forming components of different composition, introducing a specified volume of the polymer solution or solution of polymer-forming components into a set of sample vessels, forming a polymer film optionally exposing the polymer film to an increased temperature, determining, sequentially or in parallel, one or more physical properties, and selecting the polymer samples having the most favorable properties.

### BACKGROUND OF THE INVENTION

The invention relates to methods and means of acceleratedly optimizing polymer or polymer-forming components and to determining the relative degree of crosslinking using a new fluorescence test.

The profile of properties of polymer or polymer-forming materials, especially of polyurethane (PU) coating materials, but also of other coating formulations, depends in a complex and usually unpredictable way on the components of the coating materials, their relative composition, and the chosen process parameters. Important components of PU coating materials are polyisocyanates, polyols, additives such as light stabilizers and levelling agents, catalysts, and optionally organic solvents or water. This diversity of possible coating compositions make the development of coating systems a long drawn-out process in which it is attempted to approximate to a desired profile of properties by, laboriously and iteratively, varying the coating components, their relative amounts, or the reaction conditions.

Some important properties of polymer or polymer-forming materials are tied to the degree of crosslinking of the film. Examples include solvent resistance and chemical resistance. In the case of one-component (1K) PU coating systems, formulated from a polyol component and a blocked isocyanate component, an important part is played by the crosslinking temperature, the temperature at which the film actually becomes able to crosslink through elimination of the blocking agent. The properties mentioned are a function of the coating components (in the case of PU coating materials, for example, polyol, polyisocyanate, and possibly catalyst) and of method parameters such as the baking temperature and baking time, and must therefore be optimized, as mentioned at the outset, by varying the coating components and the process parameters.

For the development of new polymer or polymer-forming materials, techniques and methods which allow accelerated optimization of film properties such as the solvent resistance or crosslinking temperature of 1K baking varnishes are of great interest. Not only for the determination of the above mentioned properties but also, independently therefrom, for fast optimization of film properties in general, approaches at a solution have been described, and are briefly summarized below.

Reactive one-component (1K) polyurethane (PU) systems have acquired increasing significance in recent years in the coating of various materials, especially plastics and metals, due to their good coating properties. These 1K PU systems comprise a combination of one or more isocyanates, which have been blocked by an appropriate blocking agent, and one or more polyols, which can be stored and applied together. These one-component polyurethane systems offer the advantage over the two-component systems of greater ease of storage and application technology, since only one component, in the form of a mixture, storage-stable at room temperature, is needed for the coating. The initiation of crosslinking of the components to form a coating film usually requires a catalyst and the heating of the article to be coated at a relatively high temperature for a period of time which is dependent on the substrate to be coated and the blocking agent used.

The baking temperature differs according to the application, the blocking agent, and the choice of catalyst. The baking temperature is an important product property. In automotive OEM finishing, for example, a baking temperature of 130-160° C. is required; for packaging coating, a temperature of greater than 160°, and for coil coating a temperature of more than 200° C. The baking times differ and are about 30 minutes at low baking temperatures but 2 minutes at very high baking temperatures such as in the coil coating process.

These conditions do not permit the coating of certain materials, such as some plastics, for example, due to their deformation or yellowing. One problem associated with the use of 1K coating systems is therefore the realization of low crosslinking temperatures for these applications. An important problem is not only the use of a suitable blocking agent but also the use of a suitable catalyst. In the improvement of 1K coating systems, therefore, a major challenge is to find improved catalysts and blocking agents for the crosslinking of coating films at lower temperatures and hence also to provide a method which facilitates the search for new kinds of blocking agents and catalysts, respectively.

For the determination of the crosslinking temperature of 1K baking varnishes and thus for the search for active catalysts or blocking agents, a variety of techniques are available. An overview of these is given, inter alia, by D. A. Wicks and Z. W. Wicks in Progress in Organic Coatings, 1999, 36, 148. The principal techniques are as follows: (i) Measurements are made of the baking time and baking temperature at which a coating film withstands 200 rubs with a MEK (methyl ethyl ketone)-soaked cloth without damage. (ii) The development of the NCO band is monitored by means of IR spectroscopy. (iii) The increasing rigidity of the polymer coating film in the course of crosslinking is detected by means of dynamic mechanical analysis (DMA). (iv) The weight loss as a result of elimination and evaporation of the blocking agent is detected by means of thermogravimetric analysis (TGA).

Methods (iii) and (iv) have been described further. Method (iii) is used by T. Engbert, E. König, E. Jürgens, Farbe&Lack, Curt R. Vincentz Verlag, Hannover, October 1995, and is an established method. It involves exciting a glass fiber fabric strip impregnated with a coating mixture to torsional vibration and heating it continuously at a rate of about 2 K/min. The crosslinking of the coating film following elimination of the protective group is manifested in the sharp increase in the resonant frequency of the torsional vibration; the corresponding temperature is called the lower crosslinking temperature. DMA is inherently a sequential method and is therefore only of limited suitability for extensive systematic investigations on the way in which the crosslinking temperature depends on synthesis parameters and method parameters. Furthermore, with DMA the coating film is not tested under application conditions, i.e. as a thin film on a glass or metal surface. Method (iv) is utilized, inter alia, by I. Muramatsu, Y. Tanimoto, M. Kase and N. Okushi in Progress in Organic Coatings 1993, 22, 279-286. This procedure too, like that of dynamic mechanical analysis, is fundamentally a sequential process.

The solvent resistance of coating systems has to date been assessed sequentially in paint testing laboratories by applying an organic solvent, followed by visual and manual testing of the damage by a member of laboratory staff.

The above mentioned test methods are usually sequential laboratory methods.

A method of fast optimization of coated surfaces was recently described by WO 00/06306 and DE 19851139 A1 (BASF AG). It relates to the application of two or more coating materials or polymer films to a continuous carrier in the form of a matrix, which are subsequently subjected to radiation curing (exposure to UV light for crosslinking) and testing, with the objective of optimizing the product properties. One important aspect of that method is that a matrix of coated areas is applied to a substrate. Following radiation curing, testing is carried out to determine, in particular, the film hardness, the yellowing and/or the gloss of the different coating materials on the substrate surface. The film hardness is determined preferably by means of confocal Raman scattering.

The application and testing of two or more coating films on a substrate, i.e. the construction of a matrix of coating films, was also described in DE 44 34 972 A1. Color investigations (so-called color differences) are disclosed on clearcoat materials without pigmentation and with pigmentation (with differently modified iron oxides). The various clearcoat films are applied to one and the same black substrate, i.e. an identical continuous carrier.

It is an object of the present invention to provide a method of fast optimization of the profile of properties of polymer or polymer-forming materials, especially PU coating materials, and of identifying suitable polymer, polymer-forming components, catalysts or additives. It is another object of the invention to provide a fast method to optimize the amounts of coating components and the interaction of several coating components. It is a specific object of the invention to optimize polymer or polymer-forming materials by determination of the relative degree of crosslinking. The intention is in particular that the method should make it possible to determine the crosslinking temperature as a function of the catalysts and/or blocking agents used, for a large number of these catalysts or blocking agents simultaneously, i.e. in parallel. Preferably, the method should also allow the solvent resistance of polymer or polymer-forming materials to be determined. The methods should also be suitable for investigating 1K PU systems and other coating systems including 2K PU systems which are applied in organic solvents, 2K PU systems which are dispersible in water or 1K PU systems which are dispersible in water, or powder coating materials. The polyurethane-based coating materials should be understood as being merely exemplary alongside other coating systems.

The object is achieved in accordance with the invention by miniaturizing, automating and parallelizing the formulation, film preparation and subsequent characterization of the polymer or polymer-forming materials, on the basis for example of the relative degree of crosslinking by means of a fluorescence method.

### SUMMARY OF THE INVENTION

The invention relates to a test method for discovering a polymer or polymer-forming component having improved properties, containing the steps of

A) preparing one or more sets of polymer solutions or solutions of polymer-forming components of different composition in at least one sample preparation vessel,

B) introducing a specified volume of the sets of polymer solutions or solutions of polymer-forming components into a set of sample vessels,

C) forming a polymer film, with or without further reaction of the polymers or the polymer-forming components,

D) optionally exposing the polymer film to an increased temperature,

E) determining, sequentially or in parallel, one or more physical properties,

F) selecting the polymer sample or the polymer-forming component resulting in the film having the most favorable properties.

The invention also relates to a method for determining the effect of at least one component of a coating composition on a coating composition containing the steps of

I) preparing at least two different dye-containing films from at least one polymer or polymer-forming component, and a dye, and

II) determining one or more physical properties selected from the group consisting of degree of crosslinking, relative degree of crosslinking, solvent resistance, crosslinking temperature,

by

II a) overlaying at least two of the at least two different dye-containing films with an organic solvent thereby eluting at least a portion of the dye and,

II b) characterizing the amount of dye in the at least two eluates by an absorption or fluorescence measurement.

### DETAILED DESCRIPTION OF THE INVENTION

The invention also relates to a test method for discovering polymer or polymer-forming polymers, especially polyurethanes, having improved properties, containing the steps of

A) preparing one or more sets, in particular at least 10, with particular preference at least 24, sets of polymer solutions or solutions of polymer-forming components of different composition in sample preparation vessels.

B) introducing a specified volume of the sets of polymer solutions or solutions of polymer-forming components of in particular not more than 500 μl, with particular preference not more than 250 μl, into a set of sample vessels which have preferably each been provided with an assignment marking,

C) forming a polymer film, with or without further reaction of polymer components, having a film thickness of in particular <500 μm, with particular preference <150 μm,

D) optionally exposing the polymer film to an increased temperature, in particular at least 50° C. and preferably not more than 300° C.,

E) determining, sequentially or in parallel, one or more physical properties, especially properties selected from the degree of crosslinking, relative degree of crosslinking, hardness, gloss, solvent resistance, crosslinking temperature, especially crosslinking temperature of baking varnishes,

F) selecting the polymer samples having the most favorable properties.

The sample vessels preferably have a substantially planar base.

The polymer solutions or component solutions are metered, in particular volumetrically, into the sample preparation vessels and are then mechanically mixed, in particular by stirring, shaking, or ultrasound treatment.

The volumetric metering of the polymer solution or component solution into the sample vessels is carried out from the sample preparation vessels preferably in parallel, in particular using a pipetting robot with disposable syringes.

In one particularly preferred embodiment of the method, a set of sample preparation vessels and/or sample vessels is formed by a substrate having a large number of depressions, in particular by a microtiter plate having a large number of wells.

In one embodiment, each set of polymer solutions preferably comprises one ore more samples of identical composition, with particular preference two or more samples of identical composition.

The method is based in particular on parallel formulation and film preparation in vessels (e.g. glass vessels) which are arranged on a mount in the form of an n×m matrix (n,m>1) and which, following processing, are subjected to characterization.

The method is preferably conducted in detail as follows:

1. Different coating formulations are prepared in a plurality of vessels which are disposed on a mount in the form of an n×m matrix (n,m>1). For this purpose, the coating ingredients are metered volumetrically into the individual vessels. Mixing (formulation) takes place mechanically, for example by stirring or shaking, or else by ultrasound. The vessels here are preferably chosen to be as small as possible, in order to achieve a high degree of parallelization.

2. Coating material areas are prepared from the formulations specified in 1. in a plurality of preferably cylindrical vessels which are arranged on a mount in the form of an n×m matrix (n,m>1). Samples of the formulations specified in 1. are for this purpose metered volumetrically into the vessels, on whose base they flow out to form a film. The advantage of this procedure in comparison to the methods based on flat substrates is that the film thickness is defined by the geometry of the glass vessel and the amount of coating material used and there is no need to take further measures such as knife coating, for example, in order to adjust the film thickness. Furthermore, there is no problem in delimiting different coated areas from one another.

3. The heat treatment of the applied coating materials leads to the removal of the solvent or, where appropriate, of the dispersion medium (e.g. water) from coating formulations prepared in step 2., and/or, where appropriate, to the crosslinking of the coating components through the formation of covalent bonds.

4. The determination of the crosslinking temperature, especially of 1K baking varnishes, or the testing of the solvent resistance or of the relative degree of crosslinking on the coating material areas in vessels takes place as described below.

Fluorophore Elution

A specific fluorescence test used in certain embodiments of the invention will be referred to as fluorophore elution. It is a new analytical technique for the parallelized determination of the relative degree of crosslinking of coating materials on surfaces, and is particularly suitable for determining the crosslinking temperature of 1K baking varnishes and also the solvent resistance. The test is based on the elution of a dye from a polymer by swelling.

Pekcan et al. (Ö. Pekcan, S. Ugar, and Y. Yilmaz, Polymer, “Real-time monitoring of swelling and dissolution of poly(methyl methacrylate) discs using fluorescent probes”, 1997, 38(9), 2183; Ö. Pekcan, Y. Yilmaz, “Fluorescence Method for Monitoring Gelation and Gel Swelling in Real Time”, Appl. Fluoresc. Chem., Biol. Med., 1999, 371, 387; M. Erdogan, Ö. Pekcan, “Modeling of Swelling by the Fast Transient Fluorescence Technique in a Polymeric Gel”, Journal of Polymer Science: Part B: Polymer Physics, 2000, 38, 739) have described fluorescence-based methods by means of which the swelling of a polymer or gel sample may be investigated online. An important feature of the described methods is that a disc of a polymer sample in which a fluorescent dye (pyrene) has been dissolved during the polymerization is attached to the inner wall of a rectangular cuvette. The cuvette is filled with an organic solvent and placed in the beam path of a spectrometer. The polymer sample is affixed to the edge of the cuvette in such a way that it is not struck by the excitation beam. The solvent then swells the polymer sample and dissolves the dye, which subsequently diffuses into the cuvette. The fluorescence intensity measured in the cuvette as a function of time may then be used to characterize the swelling process.

It has been found that the fluorophore elution based on the elution of a dye by swelling permits determination of the relative degree of crosslinking of a large number of polymer or polymer-forming materials, preferably coatings on surfaces. In one preferred embodiment, it becomes possible to determine in parallel the crosslinking temperature of 1K baking varnishes.

In a preferred embodiment of the method the relative degree of crosslinking is determined by adding a dye, in particular a fluorescent dye, to the respective solution during the preparation A) or introduction B) of the polymer solution or of the polymer component solution and by carrying out the determination E) with the following steps:

J) overlaying the polymer film with a defined volume of organic solvent,

K) eluting the dye from the film over a specified activity period, in particular not more than 10 min,

L) taking a sample of the supernatant solvent at the end of the activity period and characterizing the amount of dye eluted by means of an absorption or fluorescence measurement.

In one embodiment of the method, the coating material areas are prepared in vessels (e.g. glass vessels) which are arranged on a mount in the form of a n×m matrix (n,m>1). In another embodiment, the materials are prepared in the wells of a microtiter plate. A dye, preferably a fluorescent dye, is added to the materials, preferably polymer or polymer-forming materials, during the preparation of the reaction mixture of the material, the said dye being one which does not react with the components of the polymer or polymer-forming material when the coating material is cured and which is readily soluble in organic solvents. Following film curing, the materials in the n×m matrix are overlaid, preferably for a defined time, with a suitable organic solvent—high-boiling organic solvents are preferred—by means of a pipetting robot. The solvent swells the materials and elutes all or part of the dye. After a defined activity period, a sample of the supernatant solution is analyzed. In a preferred embodiment it is taken by means of the pipetting robot and is transferred to a microtiter plate cuvette which consists of an n×m matrix of cavities. The microtiter plate cuvette is subsequently read by means of a microtiter plate fluorescence measuring station or microtiter plate absorption measuring station.

Suitable dyes for the fluorophore elution of the invention include dyes which do not react with reactive groups of the materials to form covalent bonds and which, furthermore, are readily soluble in organic solvents. Preferred dyes include polyaromatic fluorescent dyes.

Suitable solvents for the fluorophore elution of the invention are all organic solvents, but preferably high-boiling aromatic solvents such as toluene, for example.

Suitable vessels (e.g. glass vessels) for the preparation of the polymer or polymer-forming materials include cylindrical vessels with an approximately flat base. They may be used as disposable vessels, such as pill bottles.

In one preferred application method, samples of a reactive mixture of a polymer or polymer-forming material (e.g. of a 1K baking varnish) are distributed between a plurality of vessels. The films are then prepared by heating for a defined period, with each vessel being heated at a different temperature. By means of fluorophore elution it is then possible to determine the relative swellabilities of the material as a function of baking time or else baking temperature. In one preferred application of the method, the polymer or polymer-forming materials comprise 1K PU coating material mixtures. In this case, the crosslinking temperature may be measured by the method described, since above the crosslinking temperature there is a sharp drop in swellability, resulting in a precipitous reduction in the fluorescence signal. The method may also be used with equal success, however, for investigating the relative degree of crosslinking of coating films which result from 2K PU coating materials, which are dispersible in water or alternatively have been dissolved in an organic solvent, or else for 1K PU systems which are dispersible in water. The method is therefore a universal technique for investigating the relative degree of crosslinking of coating films.

Another variant of the method, which is used to select polymers on the basis of the crosslinking temperature, is characterized in that the crosslinking temperature of the polymer or of the polymer components, in particular of one-component baking varnish, is determined by

(i) dissolving a fluorescent dye as a tag in the polymer solution or polymer component solution,

(ii) preparing a plurality of coating films from the solution in different sample vessels and exposing the different sample vessels to different temperatures,

(iii) overlaying the resulting polymer film with an organic solvent that swells the coating film and elutes the dye.

(iv) using the relative dye concentration of the eluates of the films baked at different temperatures to determine the crosslinking temperature.

The tagging dyes for the aforementioned method variants comprise, in particular, fluorescent polyaromatic hydrocarbons or derivatives of polyaromatic hydrocarbons, preference being given to selecting dyes which do not react with the reactive groups, e.g. NCO, OH, amide, thiol, COOH, SO₃H or phosphate groups, that may be present in the polymers or polymer components and which are readily soluble in organic solvents, especially aromatic hydrocarbons.

The invention is further illustrated but is not intended to be limited by the following examples in which all parts and percentages are by weight unless otherwise specified.

### EXAMPLES

### Example 1

A typical experiment for determining the crosslinking temperature of solventborne 1K baking varnishes by the method of the invention proceeded as follows:

First of all, 24 coating formulations were prepared by metering the coating components using disposable pipettes of 4-5 ml size into pill bottles (capacity 10 ml, diameter approximately 15 mm). Each coating formulation included a polyol, a blocked isocyanate and a catalyst, as well as a small amount of a fluorescent dye. The pill bottles were arranged in the form of a 4-column ×6-line matrix on a carrier in microtiter plate format (MTP format).

In one example, while filling the matrix, a polyol was introduced into all of the bottles and the polyisocyanate is varied along the columns and the catalyst along the rows. The pill bottles were subsequently sealed with stoppers and the entire carrier was clamped in an overhead mixer at 200 rpm for 45 minutes. In the next step, the mother plate was copied 12 times into identical daughter plates (carriers made of Bondur) using a pipetting robot, involving the transfer each time of 100 μl of coating formulation, which flew out to a thin film on the base of the target vessels. Each daughter plate was heated for 30 min at a selected temperature from 80° C. to 190° C. (increasing in 10° C. steps), beginning with the first daughter plate, which was heated at 80° C., to the last daughter plate, which was heated at 190° C. The fluorescent dye was at this point dissolved in the coating films. After cooling in the carrier, the 288 resulting coating films in pill bottles were subjected to fluorophore elution, again by means of the pipetting robot. Each coating film was overlaid with 900 μl of toluene for 10 minutes. The solvent swelled the coating film and eluted the dye. At the end of the 10 minutes activity period, the supernatant solution was mixed and 150 μl were copied directly into a microtiter plate cuvette which was read within a few seconds using a MTP fluorescence reader. The intensities of fluorescence were normalized (corrected) in accordance with the dye concentration used in the respective coating formulation. From the relative intensities of fluorescence of solvents obtained from the coating films of one formulation, baked at different temperatures, it was possible to determine the crosslinking temperature, which was manifested in a sudden drop in the eluted dye concentration and thus in the fluorescence intensity.

Table 1 describes a pipetting worklist for the preparation of the coating formulations used in a typical experiment. The polyols and polyisocyanates are products of Bayer. These are indicated below. The catalysts were purchased from Aldrich. Tables 2-5 describe the normalized (corrected) fluorescence intensities following fluorophore elution, in arbitrary units, as a function of baking temperature for the coating formulations A1-F1, A2-F2, A3-F3 and A4-F4 from Table 1. The stated crosslinking temperature of the coating formulations is the lower of the two temperatures between which a precipitous drop in the fluorescence signal was observed. Table 6 summarizes the results of this evaluation. On the basis of these results, components of the coating formulations may be selected with a view to a desired property, in this case a low crosslinking temperature, for example. For the 1,2-dimethylpyrazole-blocked isocyanates (formulations A1-F1), for example, the lowest baking temperature was found for the formulation comprising dibutyltin dilaurate as catalyst. The method outlined here on the basis of an example is therefore suitable, for example, for searching catalysts and/or blocking agents having a desired profile of properties. Attention should be drawn to the fact that, due to the parallel procedure, different formulations can be compared under identical reaction conditions.

TABLE 1
Pipetting worklist for the formulation of 24 coating materials.

| Perylene in | | | | | | | |
|---|---|---|---|---|---|---|---|
| X/MPA¹ | | Sample | Sample | Sample | Sample | Sample | Sample |
| (5 × 10⁻⁴ M) | | A | B | C | D | E | F |
| Set | 1 | 0.5 ml | 0.5 ml | 0.5 ml | 0.5 ml | 0.5 ml | 0.5 ml |
| Set | 2 | 0.5 ml | 0.5 ml | 0.5 ml | 0.5 ml | 0.5 ml | 0.5 ml |
| Set | 3 | 0.5 ml | 0.5 ml | 0.5 ml | 0.5 ml | 0.5 ml | 0.5 ml |
| Set | 4 | 0.5 ml | 0.5 ml | 0.5 ml | 0.5 ml | 0.5 ml | 0.5 ml |
| Polyacrylatepolyol | | | | | | | |
| Desmophen A | | | | | | | |
| VP LS 2009/1 | | | | | | | |
| SC = 55%² | | A | B | C | D | E | F |
| | 1 | 2.0 ml | 2.0 ml | 2.0 ml | 2.0 ml | 2.0 ml | 2.0 ml |
| | 2 | 2.0 ml | 2.0 ml | 2.0 ml | 2.0 ml | 2.0 ml | 2.0 ml |
| | 3 | 2.0 ml | 2.0 ml | 2.0 ml | 2.0 ml | 2.0 ml | 2.0 ml |
| | 4 | 2.0 ml | 2.0 ml | 2.0 ml | 2.0 ml | 2.0 ml | 2.0 ml |
| | | Titanium (IV) | | Zirconium | Magnesium | Calcium | |
| | | 2-ethyl- | | (IV) 2-ethyl- | Perchlorate | Perchlorate | No |
| | | hexoxide | DBTL | hexanoate | in BA | in BA | Catalyst |
| Catalyst | | A | B | C | D | E | F |
| | 1 | 0.039 ml | 0.033 ml | 0.041 ml | 0.071 ml | 0.076 ml | |
| | 2 | 0.036 ml | 0.035 ml | 0.043 ml | 0.075 ml | 0.080 ml | |
| | 3 | 0.032 ml | 0.031 ml | 0.038 ml | 0.067 ml | 0.072 ml | |
| | 4 | 0.032 ml | 0.031 ml | 0.038 ml | 0.065 ml | 0.070 ml | |
| Polyisocyanates | | A | B | C | D | E | F |
| Isocyanate 1 | 1 | 1.895 ml | 1.895 ml | 1.895 ml | 1.895 ml | 1.895 ml | 1.895 ml |
| Isocyanate 2 | 2 | 2.344 ml | 2.344 ml | 2.344 ml | 2.344 ml | 2.344 ml | 2.344 ml |
| Isocyanate 3 | 3 | 1.624 ml | 1.624 ml | 1.624 ml | 1.624 ml | 1.624 ml | 1.624 ml |
| Isocyanate 4 | 4 | 1.689 ml | 1.689 ml | 1.689 ml | 1.689 ml | 1.689 ml | 1.689 ml |

¹Xylene/methoxypropyl acetate
²SC = solids content. The supply form is diluted with butyl acetate.
The polyol component is a polyacrylate polyol (tradename of Bayer AG: Desmophen A VP LS 2009-1 for 2K PU topcoat materials, which was dissolved 55% in butyl acetate.

The following isocyanates were employed for the tests:

Isocyanate 1:

This is polyisocyanate N3300 (tradename of Bayer AG, viscosity 3 200 mPas, commercial supply form 75% in 1-methoxypropyl 2-acetate/Solventnaphtha 100 (8:17) which was blocked with 3,5-dimethylpyrazole. It is dissolved to a solids content of 55% in butyl acetate.

Isocyanate 2:

This is polyisocyanate N3300 (tradename of Bayer AG, commercial supply form approximately 70% in 1-methoxypropyl 2-acetate (MPA) which was blocked with diethyl malonate. It is dissolved to a solids content of 50% in butyl acetate.

Isocyanate 3:

This is polyisocyanate N3300 (tradename of Bayer AG, commercial supply form approximately 72% in 1-methoxypropyl 2-acetate (MPA) which was blocked with ε-caprolactam. It is dissolved to a solids content of 60% in butyl acetate.

Isocyanate 4:

This is polyisocyanate N3300 (tradename of Bayer AG, commercial supply form approximately 75% in Solventnaphtha 100) which was blocked with butanone oxime. It is dissolved to a solids content of 57% butyl acetate.

TABLE 2
Fluorescence intensities (arbitrary units) at different baking
temperatures for the coating formulations A1-F1 from Table 1

| | | | | Mag- | | |
|---|---|---|---|---|---|---|
| Baking | | | | nesium | Calcium | |
| tem- | | | | per- | per- | |
| perature | Titanium | | Zirconium | chlorate | chlorate | |
| in | (IV) | DBTL | (IV) | solution | solution | |
| degrees | 2-ethyl- | (dibutyltin | 2-ethyl- | in butyl | in butyl | Without |
| Celcius | hexoxide | dilaurate) | hexanoate | acetate | acetate | cat. |
| 82.5 | 16046 | 17630 | 17262 | 16553 | 16837 | 16632 |
| 93.0 | 16227 | 18528 | 16183 | 16818 | 16471 | 16953 |
| 103.0 | 14999 | 17494 | 16025 | 16327 | 16414 | 17011 |
| 113.5 | 14323 | 15786 | 16305 | 15886 | 15904 | 16356 |
| 124.0 | 14629 | 9006 | 16017 | 15448 | 16078 | 16092 |
| 134.0 | 13638 | 8312 | 15356 | 15524 | 15531 | 15333 |
| 144.0 | 7052 | 7618 | 13943 | 15027 | 15877 | 14684 |
| 156.0 | 5845 | 5584 | 7337 | 14744 | 15172 | 14285 |
| 164.0 | 5989 | 5275 | 6317 | 7720 | 12998 | 11840 |
| 174.5 | 5278 | 4903 | 4929 | 7369 | 7533 | 7730 |
| 186.0 | 4359 | 4571 | 3163 | 6337 | 6917 | 6615 |
| 196.0 | 4171 | 4368 | 2502 | 5318 | 5852 | 5554 |

TABLE 3
Fluorescence intensities (arbitrary units) at different baking
temperatures for the coating formulations A2-F2 from Table 1

| | | | | Mag- | | |
|---|---|---|---|---|---|---|
| Baking | | | | nesium | Calcium | |
| tem- | | | | per- | per- | |
| perature | Titanium | | Zirconium | chlorate | chlorate | |
| in | (IV) | DBTL | (IV) | solution | solution | |
| degrees | 2-ethyl- | (dibutyltin | 2-ethyl- | in butyl | in butyl | Without |
| Celcius | hexoxide | dilaurate) | hexanoate | acetate | acetate | cat. |
| 82.5 | 12073 | 12546 | 12725 | 12442 | 12031 | 12903 |
| 93.0 | 9016 | 8684 | 8179 | 9319 | 8870 | 8914 |
| 103.0 | 7749 | 7324 | 7875 | 7977 | 7662 | 7416 |
| 113.5 | 6999 | 6454 | 6669 | 6603 | 6757 | 6854 |
| 124.0 | 6634 | 6101 | 6026 | 6116 | 6109 | 6484 |
| 134.0 | 5904 | 5552 | 5338 | 5946 | 5655 | 5907 |
| 144.0 | 5551 | 4657 | 4821 | 5134 | 5296 | 5353 |
| 156.0 | 4097 | 4227 | 3782 | 4637 | 5409 | 4651 |
| 164.0 | 4436 | 4223 | 3432 | 4314 | 4499 | 5604 |
| 174.5 | 4291 | 4385 | 3074 | 4406 | 5483 | 4520 |
| 186.0 | 3386 | 4431 | 2512 | 3420 | 3559 | 3716 |
| 196.0 | 3431 | 4322 | 2469 | 3040 | 3333 | 3718 |

TABLE 4
Fluorescence intensities (arbitrary units) at different baking
temperatures for the coating formulations A3-F3 from Table 1

| | | | | Mag- | | |
|---|---|---|---|---|---|---|
| Baking | | | | nesium | Calcium | |
| tem- | | | | per- | per- | |
| perature | Titanium | | Zirconium | chlorate | chlorate | |
| in | (IV) | DBTL | (IV) | solution | solution | |
| degrees | 2-ethyl- | (dibutyltin | 2-ethyl- | in butyl | in butyl | Without |
| Celcius | hexoxide | dilaurate) | hexanoate | acetate | acetate | cat. |
| 82.5 | 15496 | 17685 | 15784 | 16596 | 16929 | 16369 |
| 93.0 | 16065 | 17943 | 16277 | 15527 | 16015 | 16584 |
| 103.0 | 15014 | 17622 | 15306 | 15613 | 16252 | 16512 |
| 113.5 | 14806 | 16530 | 15208 | 15958 | 15988 | 15942 |
| 124.0 | 15247 | 17366 | 15467 | 15834 | 16546 | 16527 |
| 134.0 | 14533 | 16547 | 14993 | 15195 | 15231 | 15787 |
| 144.0 | 14044 | 16554 | 15254 | 15877 | 15663 | 15332 |
| 156.0 | 13671 | 16476 | 14706 | 15123 | 14526 | 15168 |
| 164.0 | 12877 | 14822 | 13890 | 13869 | 14000 | 14119 |
| 174.5 | 6955 | 7372 | 7239 | 7202 | 10396 | 11797 |
| 186.0 | 4945 | 4692 | 5340 | 6253 | 6251 | 6276 |
| 196.0 | 4139 | 4116 | 4386 | 5164 | 5348 | 5528 |

TABLE 5
Fluorescence intensities (arbitrary units) at different baking
temperatures for the coating formulations A4-F4 from Table 1

| | | | | Mag- | | |
|---|---|---|---|---|---|---|
| Baking | | | | nesium | Calcium | |
| tem- | | | | per- | per- | |
| perature | Titanium | | Zirconium | chlorate | chlorate | |
| in | (IV) | DBTL | (IV) | solution | solution | |
| degrees | 2-ethyl- | (dibutyltin | 2-ethyl- | in butyl | in butyl | Without |
| Celcius | hexoxide | dilaurate) | hexanoate | acetate | acetate | cat. |
| 82.5 | 14056 | 15183 | 14511 | 14967 | 15173 | 15215 |
| 93.0 | 13919 | 14847 | 13943 | 14396 | 14790 | 15045 |
| 103.0 | 13497 | 14694 | 14086 | 13868 | 14727 | 15092 |
| 113.5 | 12585 | 13874 | 13899 | 13830 | 14361 | 14767 |
| 124.0 | 13188 | 13937 | 13727 | 13973 | 14551 | 14847 |
| 134.0 | 12266 | 12242 | 13579 | 14235 | 13420 | 13543 |
| 144.0 | 7108 | 8167 | 11699 | 13724 | 13431 | 13755 |
| 156.0 | 6284 | 5653 | 6542 | 10456 | 7941 | 7831 |
| 164.0 | 4855 | 4406 | 4962 | 7525 | 7403 | 7600 |
| 174.5 | 4314 | 4095 | 3466 | 8009 | 8020 | 8005 |
| 186.0 | 3627 | 3753 | 2041 | 6507 | 6678 | 6443 |
| 196.0 | 3297 | 3583 | 1619 | 5186 | 5193 | 5152 |

TABLE 6
Crosslinking temperatures of the coating formulations A1-F4 in
degrees Celsius obtained by evaluating Tables 2-5

| | A | B | C | D | E | F |
|---|---|---|---|---|---|---|
| 1 | 134 | 113.5 | 144 | 156 | 164 | 164 |
| 2³ | (82.5) | (82.5) | (82.5) | (82.5) | (82.5) | (82.5) |
| 3 | 164 | 164 | 164 | 164 | 174 | 174 |
| 4 | 134 | 134 | 144 | 144 | 144 | 144 |

³The statement of a crosslinking temperature for the formulations A2-F2 is given in parenthesis, since no sharp temperature can be determined. The fluorescence intensities do not decrease precipitously but instead continuously with increasing temperature. This pattern of decrease may be attributed to crosslinking by slow transesterification without elimination of the blocking agent with this class of substance.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A test method for discovering a polymer or polymer-forming component having improved properties, comprising the steps of
A) preparing one or more sets of polymer solutions or solutions of polymer-forming components of different composition in at least one sample preparation vessel,
B) introducing a specified volume of the sets of polymer solutions or solutions of polymer-forming components into at least one sample vessel,
C) forming a polymer film, with or without further reaction of the polymers or the polymer-forming components,
D) optionally exposing the polymer film to an increased temperature,
E) determining, sequentially or in parallel, one or more physical properties,
F) selecting the polymer sample or the polymer-forming component resulting in the film having the most favorable properties.

2. The test method of claim 1 comprising A) preparing at least 24 sample vessels.

3. The test method of claim 1 comprising B) introducing not more than 500 μl of polymer solutions or solutions of polymer-forming components.

4. The test method of claim 1 comprising C) forming a polymer film with a thickness of less than 500 μm.

5. The test method of claim 1 comprising E) determining a property selected from the group consisting of degree of crosslinking, relative degree of crosslinking, hardness, gloss, solvent resistance, and crosslinking temperature.

6. The test method of claim 1 wherein the sample vessels have a substantially planar base.

7. The test method of claim 1 comprising E) determining the crosslinking temperature of baking varnishes.

8. The test method of claim 1 wherein the sample preparation vessel and/or the sample vessel is a part of a microtiter plate.

9. The test method of claim 1 wherein the physical property is the relative degree of crosslinking which is determined by steps comprising adding a dye to the solution during the preparation A) or introduction B) of the polymer solution or of the polymer component solution and by carrying out the determination E) comprising the following steps:
G) overlaying the polymer film with a defined volume of organic solvent,
H) eluting the dye from the film over a specified activity period,
I) taking a sample of the supernatant solvent at the end of the activity period and characterizing the amount of dye eluted by means of an absorption or fluorescence measurement.

10. The test method of claim 1 wherein the physical property is the crosslinking temperature of the polymer or of the polymer components which is determined by steps comprising
(v) dissolving a fluorescent dye as a tag in the polymer solution or polymer component solution,
(vi) preparing a plurality of coating films from the solution in different sample vessels and exposing the different sample vessels to different temperatures,
(vii) overlaying the resulting polymer film with an organic solvent that swells the coating film and elutes the dye.
(viii) using the relative dye concentration of the eluates of the films baked at different temperatures to determine the crosslinking temperature.

11. A method for determining the effect of at least one component of a coating composition on a coating composition comprising the steps of
I) preparing at least two different dye-containing films from at least one polymer or polymer-forming component, and a dye, and
II) determining one or more physical properties selected from the group consisting of degree of crosslinking, relative degree of crosslinking, solvent resistance, crosslinking temperature,
by
II a) overlaying at least two of the at least two different dye-containing films with an organic solvent thereby eluting at least a portion of the dye and,
II b) characterizing the amount of dye in the at least two eluates by an absorption or fluorescence measurement.

12. The method of claim 11 wherein the at least two different films are prepared under at least two different environmental conditions.

13. The method of claim 11 wherein the two different environmental conditions are different temperatures.

14. The method of claim 11 wherein the at least two different films are overlayed with substantially the same volume of organic solvent.

15. The method of claim 11 wherein the at least two different films are overlayed for substantially the same amount of time.

16. The test method of claim 11 wherein the sample vessels have a substantially planar base.

17. The method of claim 11 wherein the preparation vessel and/or the sample vessel is a microtiter plate.

18. The method of claim 11 further comprising
III) selecting the at least one polymer or polymer forming component that forms the film with the most favorable properties.

19. The method of claim 11 wherein the component of a coating composition comprises a polymer, a crosslinker, a catalyst, a wetting agent, a stabilizer, a levelling agent, an antioxidant, or a plasticizer.

20. The method of claim 11 wherein the dye comprises a fluorescent polyaromatic hydrocarbon or a derivative of a polyaromatic hydrocarbon and the dye does not react with NCO, OH, amide, thiol, COOH, SO₃H or phosphate groups.

21. The method of claim 11 wherein in the preparation step I) the at least one polymer forming component is a powder.

22. The method of claim 11 wherein the preparation step I) comprises
Ia) preparing at least one solution comprising one or more polymer or polymer-forming component in at least one preparation vessel,
Ib) introducing an amount of the at least one solution into at least two sample vessels, and
Ic) forming a polymer film having a film thickness of less than 500 μm.

23. The method of claim 22 wherein the preparation step I) further comprises exposing at least one sample vessel to an increased temperature of at least 50° C.

24. The method of claim 22 wherein the sample vessels have substantially the same shape.

25. The method of claim 22 wherein the sample vessels have a substantially planar base.

26. The method of claim 22 comprising metering the solution volumetrically into the sample vessels from the preparation vessel.

27. The method of claim 22 comprising metering the solution into the sample vessels from the preparation vessel in parallel.

28. The method of claim 22 wherein the preparation vessel and/or the sample vessel is a substrate having a large number of depressions.

29. The method of claim 22 wherein the preparation vessel and/or the sample vessel is a microtiter plate.

30. The method of claim 22 wherein at least two sample vessels comprise a solution or a powder having substantially identical composition.
